(19) United States
(12) Patent Application Publication
(10) Pub. No.: US 2026/0094547 A1
(43) Pub. Date: Apr. 2, 2026

(54) Reminder Device

(71) Applicant: Joseph Matthew Harbinson, Plymouth, MN (US)

(72) Inventor: Joseph Matthew Harbinson, Plymouth, MN (US)

(21) Appl. No.: 18/904,455

(22) Filed: Oct. 2, 2024

(51) Int. Cl. G09F 11/04

(52) U.S. Cl. CPC G09F 11/04

(57) ABSTRACT

A reminder device for visually representing completion of a task includes a base. A disk is coupled to the base. A plurality of apertures extend through the disk. The plurality of apertures are arranged to define a circle on the disk. A dial is rotatably positioned between the disk and the base wherein the dial is rotatable relative to the base and the disk. An indicium is positioned on the dial. The indicium is alignable with a selectable aperture of the plurality of apertures such that the indicium is visible though the selectable aperture of the plurality of apertures when the dial is rotated wherein the indicium is designed to provide visual representation of completion of a task.

### (b) CROSS-REFERENCE TO RELATED APPLICATIONS

Not Applicable

### (c) STATEMENT REGARDING FEDERALLY SPONSORED RESEARCH OR DEVELOPMENT

Not Applicable

### (d) THE NAMES OF THE PARTIES TO A JOINT RESEARCH AGREEMENT

Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### (f) STATEMENT REGARDING PRIOR DISCLOSURES BY THE INVENTOR OR JOINT INVENTOR

Not Applicable

### (g) BACKGROUND OF THE INVENTION

### (1) Field of the Invention

The disclosure relates to task completion trackers and more particularly pertains to a new task completion tracker for visually representing completion of a task.

### (2) Description of Related Art Including Information Disclosed Under 37 CFR 1.97 and 1.98

The prior art relates to task completion trackers. Task completion trackers come in many forms, the most common of which are lists commonly made in notebooks or on other pieces of paper. However, such paper-based task trackers are easy to misplace, resulting in minimal utility. Thus, there is a need for a device which would indicate that a task has been completed, to remind users whether the task was already completed, or whether the task still needs to be completed. Ideally, such a device would include notations indicating the time, or date, on which the task was last completed. Such a device would also ideally be configured for storage on, or near, objects used in completing the task, so that the user always has the device ready when the task is completed.

### (h) BRIEF SUMMARY OF THE INVENTION

An embodiment of the disclosure meets the needs presented above by generally comprising a base. A disk is coupled to the base. A plurality of apertures extend through the disk. The plurality of apertures are arranged to define a circle on the disk. A dial is rotatably positioned between the disk and the base wherein the dial is rotatable relative to the base and the disk. An indicium is positioned on the dial. The indicium is alignable with a selectable aperture of the plurality of apertures such that the indicium is visible though the selectable aperture of the plurality of apertures when the dial is rotated wherein the indicium is configured to provide visual representation of completion of a task.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top isometric view of a reminder device according to an embodiment of the disclosure.

FIG. 2 is an exploded view of an embodiment of the disclosure.

FIG. 3 is a top view of an embodiment of the disclosure.

FIG. 4 is a cross-sectional view of an embodiment of the disclosure.

FIG. 5 is a bottom isometric view of an embodiment of the disclosure.

FIG. 6 is a bottom isometric view of an embodiment of the disclosure.

FIG. 7 is a bottom isometric view of an embodiment of the disclosure.

FIG. 8a is an exploded view of an embodiment of the disclosure.

FIG. 8b is a bottom isometric view of an embodiment of the disclosure.

FIG. 9 is a top view of an embodiment of the disclosure.

FIG. 10 is a top view of an embodiment of the disclosure.

FIG. 11 is a top view of an embodiment of the disclosure.

FIG. 12 is a top view of an embodiment of the disclosure.

### (j) DETAILED DESCRIPTION OF THE INVENTION

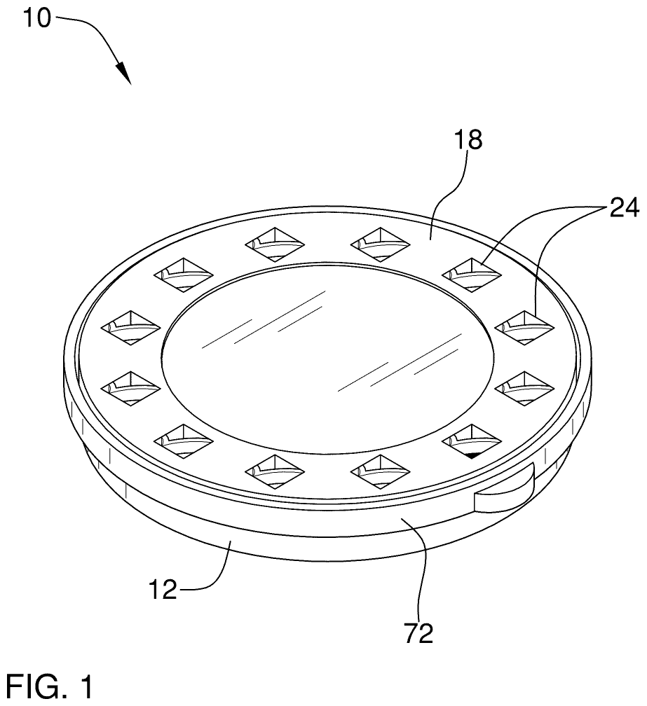

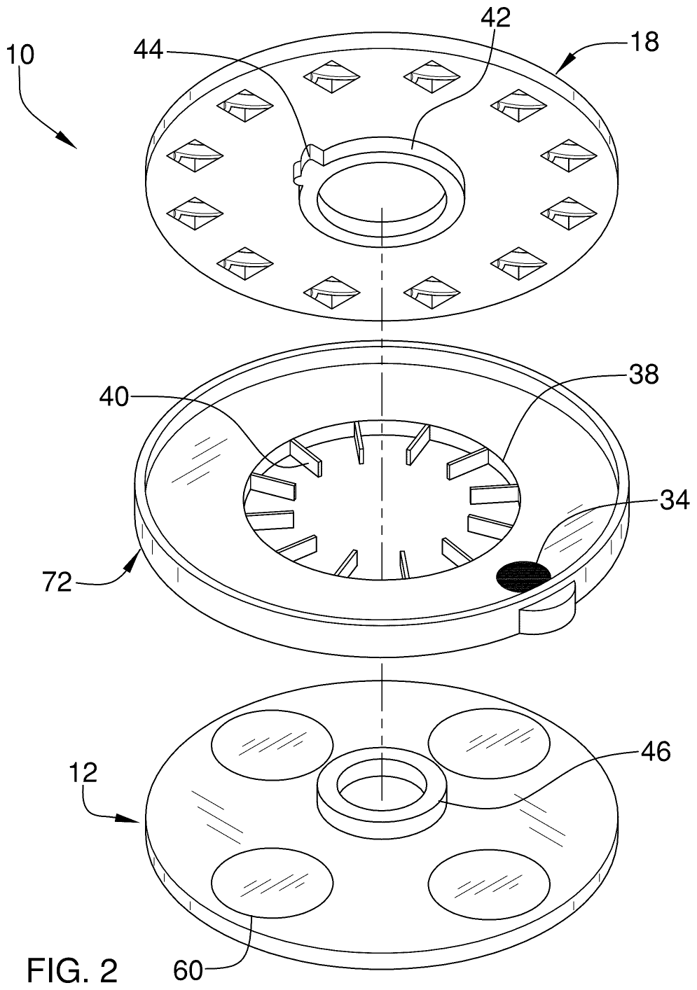

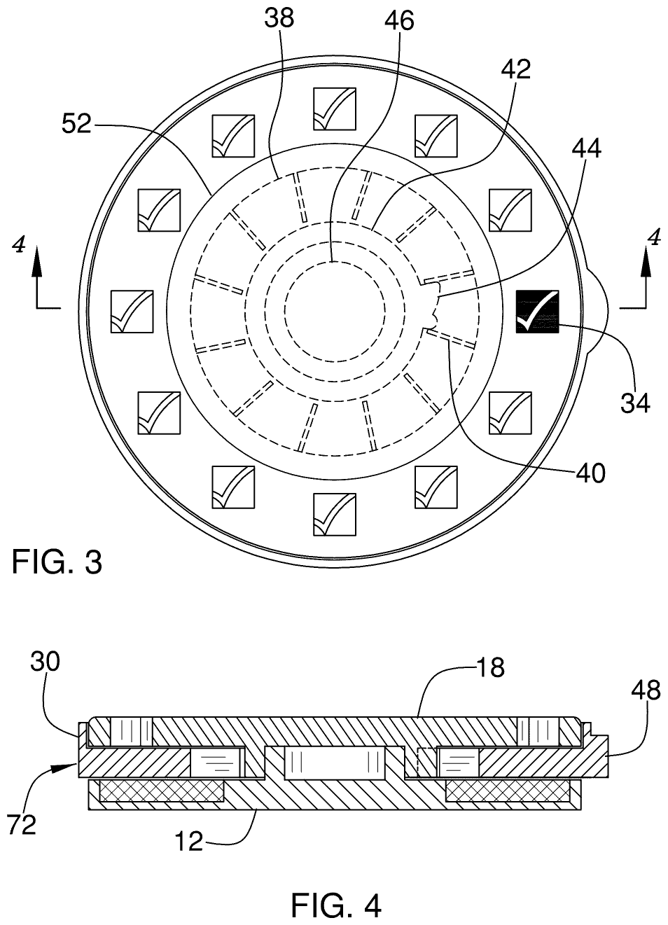

With reference now to the drawings, and in particular to FIGS. 1 through 12 thereof, a new task completion tracker embodying the principles and concepts of an embodiment of the disclosure and generally designated by the reference numeral 10 will be described.

As best illustrated in FIGS. 1 through 12, the reminder device 10 generally comprises a base 12. The base 12 generally has an upper side 14 and a lower side 16. A disk 18 is coupled to the base 12. More specifically, the disk 18 is generally coupled to the upper side 14 of the base 12. The disk 18 generally includes a top surface 20 and a bottom surface 22. The bottom surface 22 is generally planar.

A plurality of apertures 24 extend through the disk 18. The plurality of apertures 24 are generally arranged to define a circle on the disk 18. The circle may be positioned proximate to an external edge 26 of the disk 18. Each aperture of the plurality of apertures 24 may have a square shape, as shown in FIG. 1. Alternatively, the plurality of apertures 24 may be circular, as shown in FIG. 12. Other shapes are also contemplated.

A dial 72 is rotatably positioned between the disk 18 and the base 12 wherein the dial 72 is rotatable relative to the base 12 and the disk 18. The dial 72 may include a plate 28 and a lip 30 that is coupled to and extends upwardly from the plate 28. For example, the lip 30 may be positioned to extend from an outer edge 32 of the plate 28. The plate 28 generally has a diameter exceeding a diameter of the disk 18 wherein the lip 30 is positioned to circumscribe the disk 18 while the bottom surface 22 of the disk 18 is positioned flush against the plate 28. The plate 28 is generally planar wherein the plate 28 is rotatable beneath the bottom surface 22 of the disk 18 while the disk 18 and the base 12 are statically positioned relative to each other. In other words, the dial 72 is rotatable relative to the base 12 and the disk 18, but neither the disk 18 nor the base 12 need to be rotatable relative to each other.

An indicium 34 is positioned on the dial 72. The indicium 34 is alignable with a selectable aperture of the plurality of apertures 24 such that the indicium 34 is visible though the selectable aperture of the plurality of apertures 24 when the dial 72 is rotated wherein the indicium 34 is configured to provide a visual representation of completion of a task. For example, the dial 72 may be rotated to position the indicium 34 beneath the selectable aperture of the plurality of apertures 24 to show that the task has been completed. The indicium 34 may be printed on the dial 72. The indicium 34 may be green, wherein the color of the indicium is configured to provide the visual representation of completion of the task, but other colors are also contemplated.

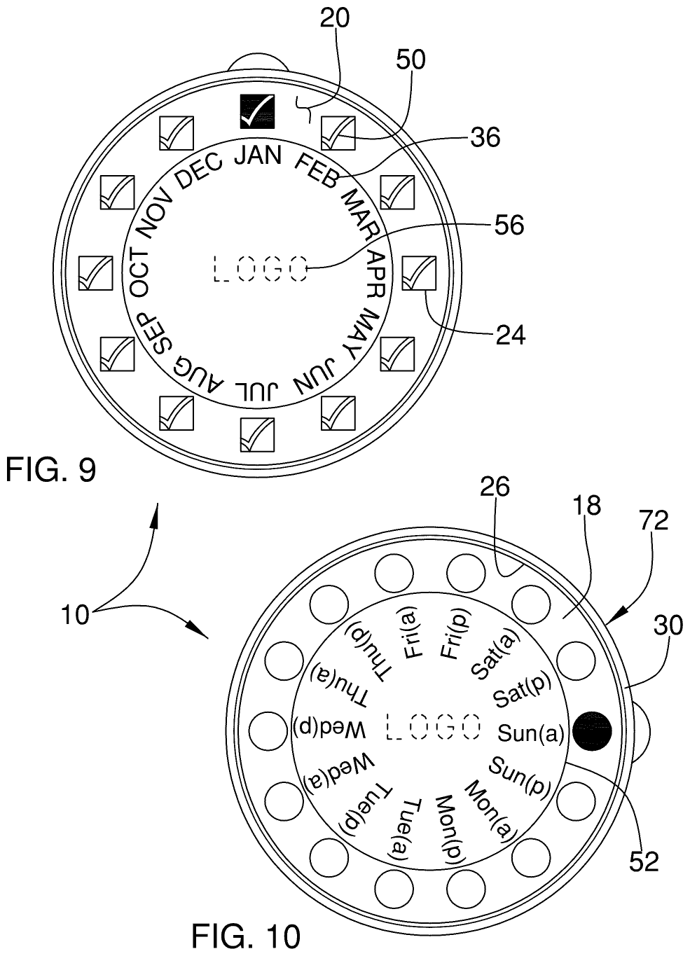

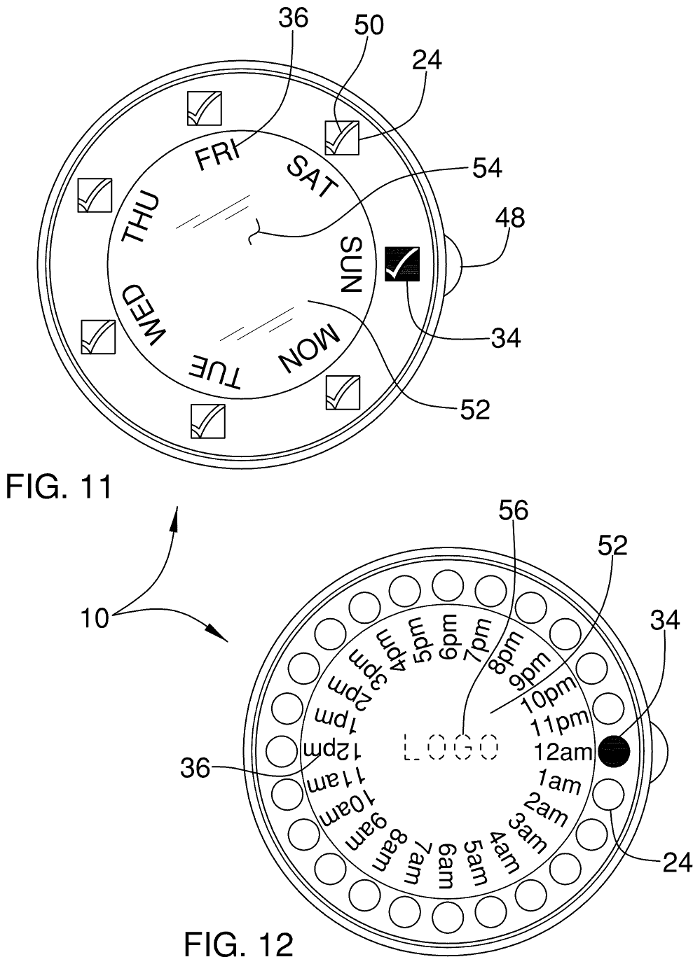

A plurality of labels 36 may be positioned on the top surface 20 of the disk 18. Each label of the plurality of labels 36 is generally positioned adjacent to a respective aperture of the plurality of apertures 24 wherein the plurality of labels 36 are configured to provide a visual representation of a time at which the task was last completed. For example, the plurality of labels 36 may include months, as shown in FIG. 9, days, as shown in FIGS. 10 and 11, and times, as shown in FIG. 12. More specifically, when a user needs to take a medication twice per day, the FIG. 10 embodiment may be used to help the user track the last time the task was completed (i.e., when the medication was last taken.) When the user takes the medication on Sunday morning, the user can rotate the dial 72 so that the indicium 34 is positioned beneath the respective aperture that is adjacent to the “Sun (a)” label. The user can then subsequently look at the reminder device 10 to remember when the medication was last taken.

Similarly, when the task needs to be completed monthly, or every few months, the embodiment in FIG. 9 may be used. For example, if the task is to replace an air filter, the dial 72 can be rotated until the indicium 34 is positioned beneath the respective aperture adjacent to the label for the month when the air filter was last replaced (January, in our example using FIG. 9.) In subsequent months, the user can simply look at the indicium 34 to remember when the air filter was last replaced.

As shown in FIGS. 9 and 11, the plurality of labels 36 may be printed horizontally on the top surface 20 of the disk 18 to maximize space within a center of the disk 18. As shown in FIGS. 10 and 12, the plurality of labels 36 may be printed vertically on the top surface 20 of the disk 18, for example to increase a number of apertures of the plurality of apertures 24 which can be included.

A hole 38 may extend through the plate 28 of the dial 72. The hole 38 may be centered on the plate 28 of the dial 72. A plurality of flanges 40 may be coupled to and extend outwardly from the plate 28 of the dial 72 into the hole 38. The plurality of flanges 40 may be spaced from each other by a distance that is complementary to a distance between adjacent pairs of the plurality of apertures 24 wherein adjacent pairs of the plurality of flanges 40 are positioned to flank each aperture of the plurality of apertures 24.

A hub 42 may be coupled to the bottom surface 22 of the disk 18. The hub 42 generally extends outwardly from the bottom surface 22 of the disk 18. The hole 38 may have a diameter exceeding a diameter of the hub 42 wherein the hub 42 is positioned to extend through the hole 38 while the dial 72 is positioned between the disk 18 and the base 12. The hub 42 may be circular. The hub 42 may be centered on the bottom surface 22 of the disk 18.

A projection 44 may be coupled to and extend outwardly from the hub 42. The projection 44 is generally positionable between adjacent pairs of the plurality of flanges 40 wherein the projection 44 is configured to facilitate aligning the indicium 34 on the dial 72 with the selectable aperture of the plurality of apertures 24. The projection 44 may have a size that is complementary to a distance between adjacent pairs of the plurality of flanges 40 wherein the projection 44 is configured to releasably secure a position of the dial 72 relative to the disk 18. For example, the projection 44 may contact adjacent pairs of the plurality of flanges to retain the position of the dial 72 relative to the disk 18. In other words, the projection 44 and the plurality of flanges inhibit the dial 72 from being rotated unless the user manually rotates the dial 72, for example by pushing on the grip 48.

In embodiments according to FIGS. 1-7, a ring 46 may be coupled to the base 12. The ring 46 generally extends upwardly from the upper side 14 of the base 12. The hub 42 may have a diameter exceeding a diameter of the ring 46 wherein the hub 42 circumscribes the ring 46. The ring 46 is thereby configured to secure a position of the disk 18 relative to the base 12. In other words, the hub 42 circumscribes the ring 46 to inhibit the disk 18 from sliding or moving laterally on the base 12. The hub 42 and the ring 46 may each be circular to facilitate rotation of the dial 72 between the base 12 and the disk 18.

A grip 48 may be coupled to and extend outwardly from the lip 30 of the dial 72. The grip 48 is generally configured to facilitate rotation of the dial 72 relative to the disk 18. As shown in the Figures, the grip 48 may be hemispherical. The user may exert pressure on the grip 48 to rotate the dial 72 between the disk 18 and the base 12.

A plurality of ribs 50 may be coupled to the disk 18. Each rib of the plurality of ribs 50 is generally positioned within an associated aperture of the plurality of apertures 24. Each rib of the plurality of ribs 50 may have a check-mark shape wherein the plurality of ribs 50 are configured to provide the visual representation of completion of the task. The plurality of ribs 50 may also have other shapes, for example to represent the task being completed. More specifically, when the reminder device 10 is being used to track when the user gave their pets a dose of a flea and tick medication, each rib of the plurality of ribs 50 may have a shape that resembles the pet. In another example, the plurality of ribs 50 may each have a shape that corresponds with each respective label of the plurality of labels. More specifically, the rib within the respective aperture adjacent to the label for “MONDAY” may have an “M” shape, while the rib within the respective aperture adjacent to the label for “WEDNESDAY”may have a “W”shape.

A panel 52 may be positioned on the top surface 20 of the disk 18, for example within the circle that is defined by the plurality of apertures 24. The panel 52 may be centered on the top surface 20 of the disk 18. The panel 52 may be planar. The plurality of labels 36 may be positioned on the panel 52.

In embodiments according to FIGS. 1 and 11, the panel 52 may include a whiteboard material 54 wherein the panel 52 is configured to facilitate the user in writing the task being tracked using a dry erase marker. For example, when the user is tracking the last time the user took certain medications, the user may write “MEDS” or another term on the whiteboard material 54. The whiteboard material 54 also allows the user to adjust which task is being tracked using the reminder device 10.

In embodiments according to FIGS. 9 and 10, the panel may include a logo 56 that is configured to represent the task being tracked. For example, the logo 56 may be a trademark associated with a particular brand of a particular product that is used for the task, such as a brand of medication or a brand of air filters. The logo 56 may be printed directly on the panel 52. Alternatively, the logo 56 may be positioned on a sticker that is adhesively engageable with the panel 52.

A coupler 58 may be coupled to the base 12. The coupler 58 is generally configured to releasably secure the base 12 to a surface wherein the coupler 58 is configured to facilitate the user in visualizing the visual representation of completion of the task. For example, the coupler 58 may releasably secure the base 12 (along with the dial 72 and the disk 18) to a furnace where the user is tracking replacement of air filters, or to a wall or cupboard near where the user stores medications.

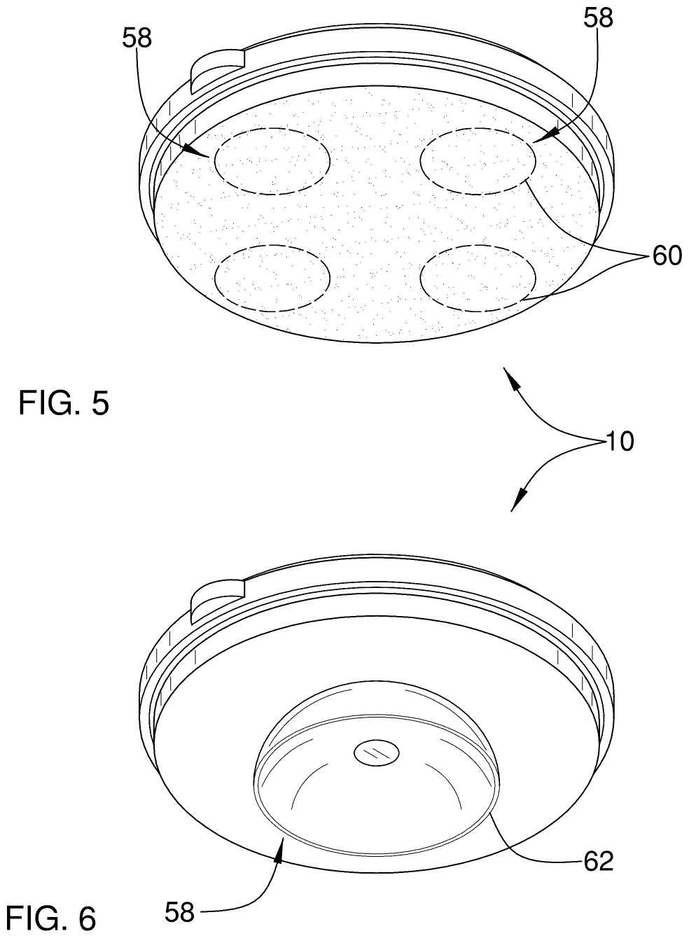

As shown in FIG. 5, the coupler 58 may include a plurality of magnets 60. The plurality of magnets 60 may be positioned, or even embedded, within the base 12. Alternatively, the plurality of magnets 60 may be coupled to the lower side 16 of the base 12. The plurality of magnets 60 are generally configured to magnetically engage a magnetic material of the surface.

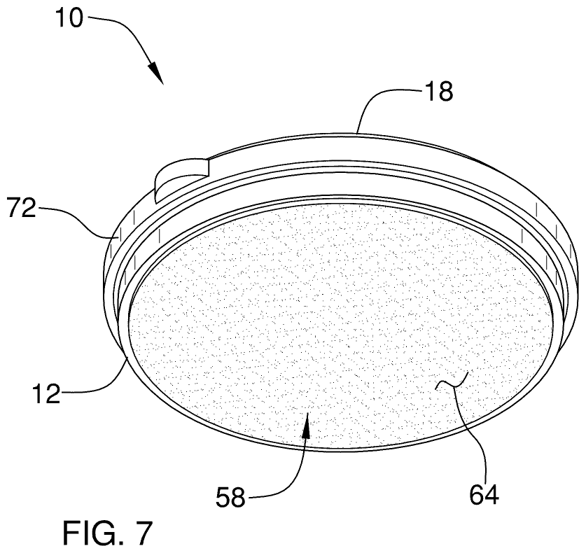

As shown in FIG. 6, the coupler 58 may include a suction cup 62 that is coupled to and extends outwardly from the lower side 16 of the base 12. As shown in FIG. 7, the coupler 58 may include a hook and loop material 64 that is coupled to the lower side 16 of the base 12. For example, the hook and loop material 64 may be VELCRO® pieces or COMMAND™ strips.

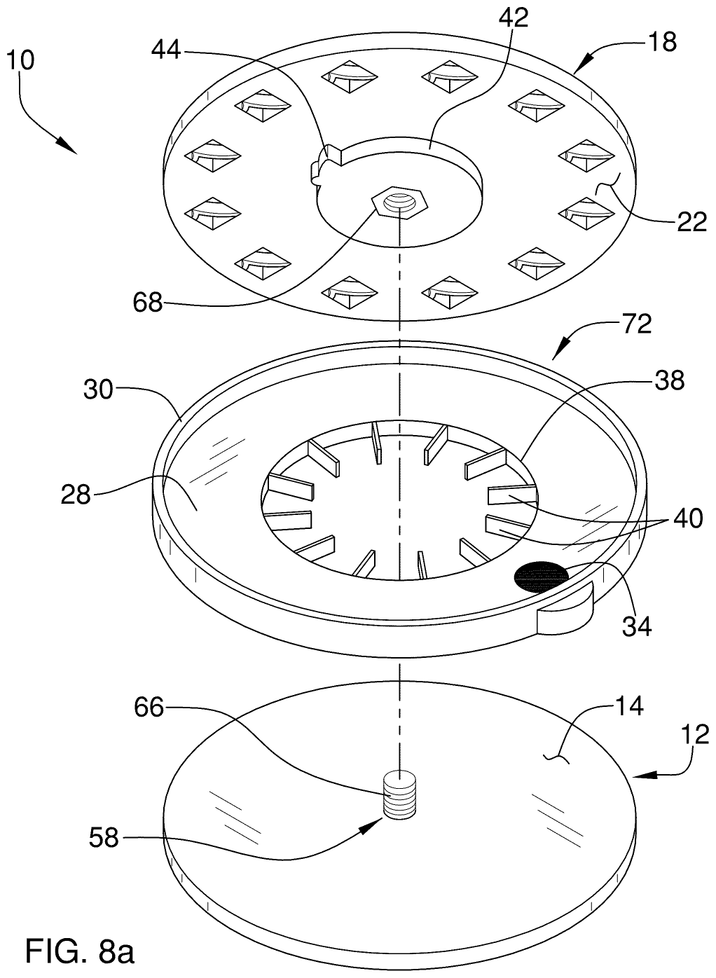

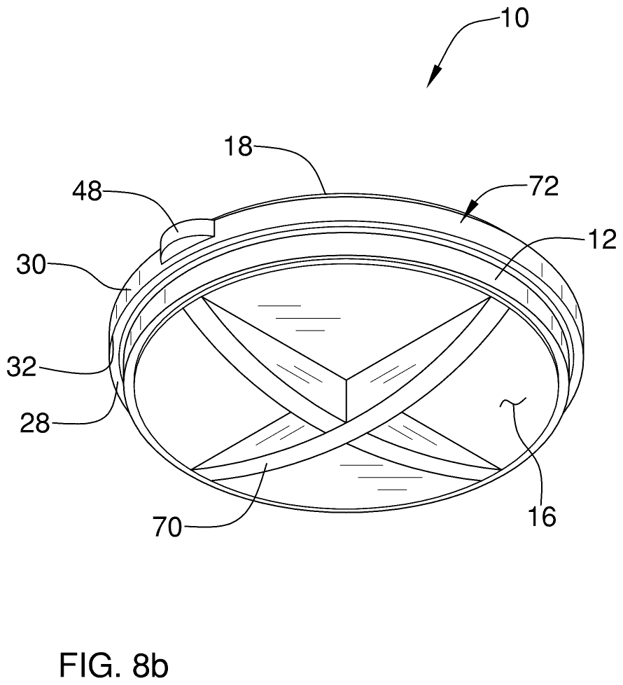

As shown in FIGS. 8a and 8b, the coupler 58 may include a post 66 that is coupled to and extends upwardly from the upper side 14 of the base 12. The post 66 is generally threaded. A bore 68 may extend into the hub 42. The bore 68 generally has a threading that is complementary to a threading of the post 66 wherein the post 66 is threadably couplable to the bore 68 extending into the hub 42 to secure the base 12 to the disk 18. Some embodiments may also include a handle 70 that is coupled to and extends outwardly from the lower side 16 of the base 12. The handle 70 is generally configured to facilitate the user in threadably coupling the post 66 to the bore 68 to secure the base 12 to the disk 18.

In use, the reminder device 10 can be stored anywhere, using the coupler 58. For example, when the coupler 58 includes the post 66 and the bore 68, the disk 18 and the dial 72 can be removed from the base 12, the base 12 can be positioned inside a cardboard box, such as a box of flea and tick medication for a pet, the post 66 can be pushed through the cardboard box, and the post 66 can be threadably coupled to the bore 68. That way, the user will see the reminder device 10 every time the user looks at the box of flea and tick medication, providing the visual representation of whether the user has given their pet the flea and tick medications.

The panel 52 can be used to identify the task that is being tracked, or a particular product that is associated with the task. In the flea and tick medication example above, the panel 52 may include the logo 56 for the brand of flea and tick medication that the user prefers for their pet. Alternatively, the panel 52 may include the whiteboard material 54, allowing the user to write their own identifying label on the reminder device 10. The panel 52 is thereby configured to help the user remember which task is being tracked by the reminder device. For example, the user may have multiples of the reminder device 10, for tracking multiple tasks, and the panel 52 may allow the user to differentiate between the various reminder devices 10 and tasks.

Once the user has completed the relevant task, the user can rotate the dial 72 to position the indicium 34 beneath the selectable aperture of the plurality of apertures 24 that corresponds with the day, or time, at which the user completed the task. When the user next looks at the reminder device 10, the user will be provided with the visual representation of the day, or time, at which the task was last completed. For example, the user may have trouble remembering when an air filter was last replaced, or when the gutters of their home were last cleaned. The reminder device 10 provides a quick, visual reminder of when those tasks were last completed. The plurality of labels 36 clarify the day, or time, at which the tasks were last completed.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A visual reminder assembly comprising:
a base;
a disk being coupled to the base;
a plurality of apertures extending through the disk, the plurality of apertures being arranged to define a circle on the disk;
a dial being rotatably positioned between the disk and the base wherein the dial is rotatable relative to the base and the disk; and
an indicium being positioned on the dial, the indicium being alignable with a selectable aperture of the plurality of apertures such that the indicium is visible though the selectable aperture of the plurality of apertures when the dial is rotated wherein the indicium is configured to provide visual representation of completion of a task.

2. The visual reminder assembly of claim 1, further comprising a plurality of labels being positioned on the top surface of the disk, each label of the plurality of labels being positioned adjacent to a respective aperture of the plurality of apertures wherein the plurality of labels are configured to provide visual representation of a time at which the task was last completed.

3. The visual reminder assembly of claim 1, further comprising a grip being coupled to and extending outwardly from the dial wherein the grip is configured to facilitate rotation of the dial relative to the disk.

4. The visual reminder assembly of claim 1, further comprising a panel being positioned on a top surface of the disk.

5. The visual reminder assembly of claim 4, the panel further comprising a whiteboard material wherein the panel is configured to facilitate a user in identifying the task using a dry erase marker.

6. The visual reminder assembly of claim 4, the panel further comprising a logo being configured to represent the task.

7. The visual reminder assembly of claim 1, further comprising a coupler being coupled to the base, the coupler being configured to releasably secure the base to a surface.

8. The visual reminder assembly of claim 7, the coupler further comprising a plurality of magnets being configured to magnetically engage a magnetic material of the surface.

9. The visual reminder assembly of claim 7, the coupler further comprising a suction cup being coupled to and extending outwardly from a lower side of the base.

10. The visual reminder assembly of claim 7, the coupler further comprising a hook and loop material being coupled to a lower side of the base.

11. The visual reminder assembly of claim 7, the coupler further comprising:
a post being coupled to and extending upwardly from an upper side of the base, the post being threaded; and
a bore extending into the hub, the bore having a threading being complementary to a threading of the post wherein the post is threadably couplable to the bore extending into the hub to secure the base to the disk.

12. The visual reminder assembly of claim 11, further comprising a handle being coupled to and extending outwardly from a lower side of the base wherein the handle is configured to facilitate a user in threadably coupling the post to the bore to secure the disk to the base.

13. The visual reminder assembly of claim 1, further comprising:
a hole extending through the dial;
a plurality of flanges being coupled to and extending outwardly from the dial into the hole;
a hub being coupled to the disk, the hub extending downwardly from the disk, the hole having a diameter exceeding a diameter of the hub wherein the hub is positioned to extend through the hole when the dial is positioned between the disk and the base; and
a projection being coupled to and extending outwardly from the hub, the projection being positionable between adjacent pairs of the plurality of flanges wherein the projection is configured to facilitate aligning the indicium on the dial with the selectable aperture of the plurality of apertures.

14. The visual reminder assembly of claim 13, wherein the plurality of flanges are spaced from each other by a distance being complementary to a distance between adjacent pairs of the plurality of apertures wherein adjacent pairs of the plurality of flanges are positioned to flank each aperture of the plurality of apertures.

15. The visual reminder assembly of claim 14, wherein the projection has a size being complementary to a distance between adjacent pairs of the plurality of flanges wherein the projection is configured to releasably secure a position of the dial relative to the disk.

16. The visual reminder assembly of claim 13, further comprising a ring being coupled to the base, the ring extending upwardly from the base, the hub having a diameter exceeding a diameter of the ring wherein the hub circumscribes the ring and wherein the ring is configured to secure a position of the disk relative to the base.

17. The visual reminder assembly of claim 16, wherein the hole has a diameter exceeding a diameter of the ring wherein the ring is positionable to extend through the hole to be circumscribed by the ring.

18. The visual reminder assembly of claim 1, further comprising a plurality of ribs being coupled to the disk, each rib of the plurality of ribs being positioned within an associated aperture of the plurality of apertures, each rib of the plurality of ribs having a check-mark shape wherein the plurality of ribs are configured to provide the visual representation of completion of the task;

19. A visual reminder assembly comprising:
a base having an upper side and a lower side;
a disk being coupled to the upper side of the base, the disk having a top surface and a bottom surface, the bottom surface being planar;
a plurality of apertures extending through the disk, the plurality of apertures being arranged to define a circle on the disk wherein the circle is positioned proximate to an external edge of the disk;
a dial being rotatably positioned between the disk and the base wherein the dial is rotatable relative to the base and the disk, the dial including a plate and a lip being coupled to and extending upwardly from an outer edge of the plate, the plate having a diameter exceeding a diameter of the disk wherein the lip is positioned to circumscribe the disk while the bottom surface of the disk is positioned flush against the plate, the plate being planar wherein the plate is rotatable beneath the bottom surface of the disk while the disk and the base are statically positioned relative to each other;
an indicium being positioned on the dial, the indicium being alignable with a selectable aperture of the plurality of apertures such that the indicium is visible though the selectable aperture of the plurality of apertures when the dial is rotated wherein the indicium is configured to provide visual representation of completion of a task;
a plurality of labels being positioned on the top surface of the disk, each label of the plurality of labels being positioned adjacent to a respective aperture of the plurality of apertures wherein the plurality of labels are configured to provide visual representation of a time at which the task was last completed;
a hole extending through the plate of the dial, the hole being centered on the plate of the dial;
a plurality of flanges being coupled to and extending outwardly from the plate of the dial into the hole, the plurality of flanges being spaced from each other by a distance being complementary to a distance between adjacent pairs of the plurality of apertures wherein adjacent pairs of the plurality of flanges are positioned to flank each aperture of the plurality of apertures;
a hub being coupled to the bottom surface of the disk, the hub extending outwardly from the bottom surface of the disk, the hole having a diameter exceeding a diameter of the hub wherein the hub is positioned to extend through the hole when the dial is positioned between the disk and the base, the hub being circular, the hub being centered on the bottom surface of the disk;
a projection being coupled to and extending outwardly from the hub, the projection being positionable between adjacent pairs of the plurality of flanges wherein the projection is configured to facilitate aligning the indicium on the dial with the selectable aperture of the plurality of apertures, the projection having a size being complementary to a distance between adjacent pairs of the plurality of flanges wherein the projection is configured to releasably secure a position of the dial relative to the disk;
a grip being coupled to and extending outwardly from the lip of the dial wherein the grip is configured to facilitate rotation of the dial relative to the disk;
a plurality of ribs being coupled to the disk, each rib of the plurality of ribs being positioned within an associated aperture of the plurality of apertures, each rib of the plurality of ribs having a check-mark shape wherein the plurality of ribs are configured to provide the visual representation of completion of the task;
a panel being positioned on the top surface of the disk within the circle being defined by the plurality of apertures, the panel being centered on the top surface of the disk, the panel being planar; and
a coupler being coupled to the base, the coupler being configured to releasably secure the base to a surface wherein the coupler is configured to facilitate a user in visualizing the visual representation of completion of the task.
